(19) United States
(12) Patent Application Publication
(10) Pub. No.: US 2025/0198470 A1
(43) Pub. Date: Jun. 19, 2025

(54) BRAKE DUST SHIELD DESIGN FOR BRAKE DUST SHIELD ROBUSTNESS

(71) Applicant: Ford Global Technologies, LLC, Dearborn, MI (US)

(72) Inventor: Todd Anthony Brittingham, White Lake, MI (US)

(21) Appl. No.: 18/538,142

(22) Filed: Dec. 13, 2023

(51) Int. Cl. F16D 65/00; B60B 27/00

(52) U.S. Cl. CPC F16D 65/0031; B60B 27/0052; B60B 2900/133; B60B 2900/311; B60B 2900/325

(57) ABSTRACT

A brake dust shield for a wheel assembly for a vehicle may be provided. A brake dust shield may include a central body portion that may be radially centered along a wheel axis in a first plane substantially perpendicular to the wheel axis, and a peripheral body portion that may be positioned radially outward from the central body portion disposed at least in part in a second plane spaced apart from the first plane along the wheel axis. The central body portion may be operably coupled to the wheel assembly via a knuckle of the wheel assembly, and the peripheral body portion may include a positive axial offset surface that may be axially offset from the first plane in a direction extending away from the brake rotor.

### TECHNICAL FIELD

Example embodiments generally relate to wheel assembly components and, more particularly, relate to a brake dust shield design for increased brake dust shield robustness.

### BACKGROUND

Some vehicles utilize brake dust shields in a wheel assembly designed to help protect wheel assembly and suspension assembly components. Brake dust shields are designed to help limit the wheel assembly and suspension assembly components exposure to the heat generated by the brake assembly during braking. The brake dust shields additionally serve to protect the brake assembly components such as the brake rotor, brake pads, and brake calipers from dust, debris, and other environmental factors that may affect the durability of the brake assembly.

Often, brake dust shields may experience bending during the manufacturing process that results in a portion of the brake dust shield contacting a brake rotor upon installation on a vehicle. This contact between the bent brake dust shield and the brake rotor may cause unwanted noise for an operator of the vehicle. While brake dust shield bending is a reality due to their design limitations and the heavy machinery involved, preventing contact with the brake rotor to limit unwanted noise may be achievable. Therefore, there is a need for a brake dust shield with increased robustness that prevents contact between a brake dust shield, either bent or unbent, and a brake rotor within a wheel assembly.

### BRIEF SUMMARY OF SOME EXAMPLES

In accordance with an example embodiment, a brake dust shield for a wheel assembly for a vehicle may be provided. The brake dust shield may include a central body portion that may be radially centered along a wheel axis in a first plane substantially perpendicular to the wheel axis, and a peripheral body portion that may be positioned radially outward from the central body portion disposed at least in part in a second plane spaced apart from the first plane along the wheel axis. The central body portion may be operably coupled to the wheel assembly via a knuckle of the wheel assembly, and the peripheral body portion may include a positive axial offset surface that may be axially offset from the first plane in a direction extending away from the brake rotor.

In another example embodiment, a wheel assembly for a vehicle of an example embodiment may be provided. The wheel assembly of the vehicle may include a knuckle for operably coupling the wheel assembly and a suspension assembly of the vehicle, a brake rotor for slowing the vehicle, a wheel bearing that may be operably coupled to the knuckle and the brake rotor, and a brake dust shield that may be disposed proximate to the brake rotor. The brake dust shield may include a central body portion that may be radially centered along a wheel axis in a first plane substantially perpendicular to the wheel axis, and a peripheral body portion that may be positioned radially outward from the central body portion disposed at least in part in a second plane spaced apart from the first plane along the wheel axis. The central body portion may be operably coupled to the wheel assembly via a knuckle of the wheel assembly, and the peripheral body portion may include a positive axial offset surface that may be axially offset from the first plane in a direction extending away from the brake rotor.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 depicts a block diagram of a wheel assembly for a vehicle wheel system in accordance with an example embodiment;

FIG. 2 illustrates a cross-section side view of a wheel assembly in accordance with an example embodiment;

FIG. 3 depicts a cross-section side view of a wheel assembly in accordance with an example embodiment;

FIG. 4 illustrates a perspective view of the wheel assembly in accordance with an example embodiment;

FIG. 5 depicts a side view of the wheel assembly in accordance with an example embodiment;

FIG. 6 illustrates a cross-section side view of a wheel assembly in accordance with an example embodiment;

FIG. 7 depicts a separated view of a wheel assembly in accordance with an example embodiment;

FIG. 8 illustrates a top view of a brake dust shield in accordance with an example embodiment; and

FIG. 9 depicts a perspective view of a brake dust shield in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments described herein may address the issues described above. In this regard, for example, some embodiments may provide a brake dust shield with a built-in axial offset away from the brake rotor to prevent deflection of the brake dust shield to contact the brake rotor and thereby increase operator comfort and satisfaction by limiting unwanted noise. Some embodiments may provide for the brake dust shield to be mounted in plane with other wheel assembly components. As a result, installation of the wheel assembly may require less effort, fewer components, less time and thus may be more efficient.

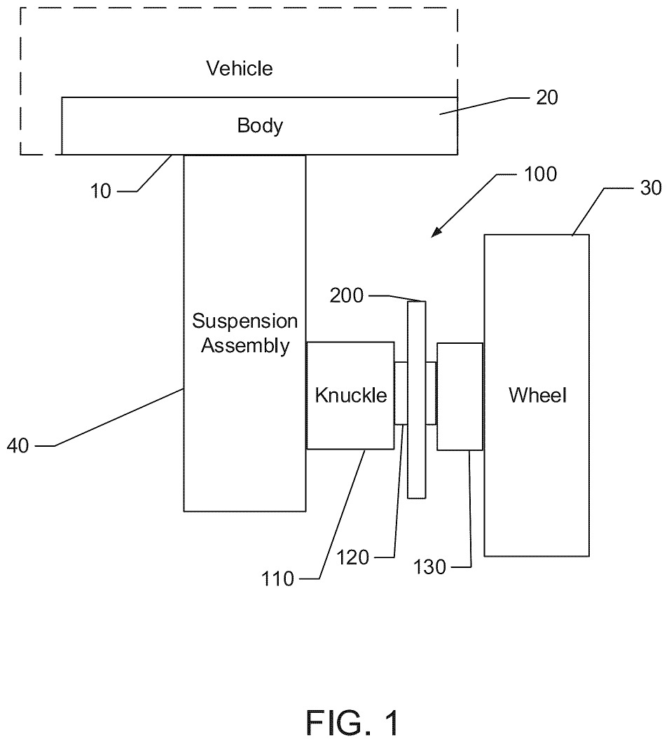

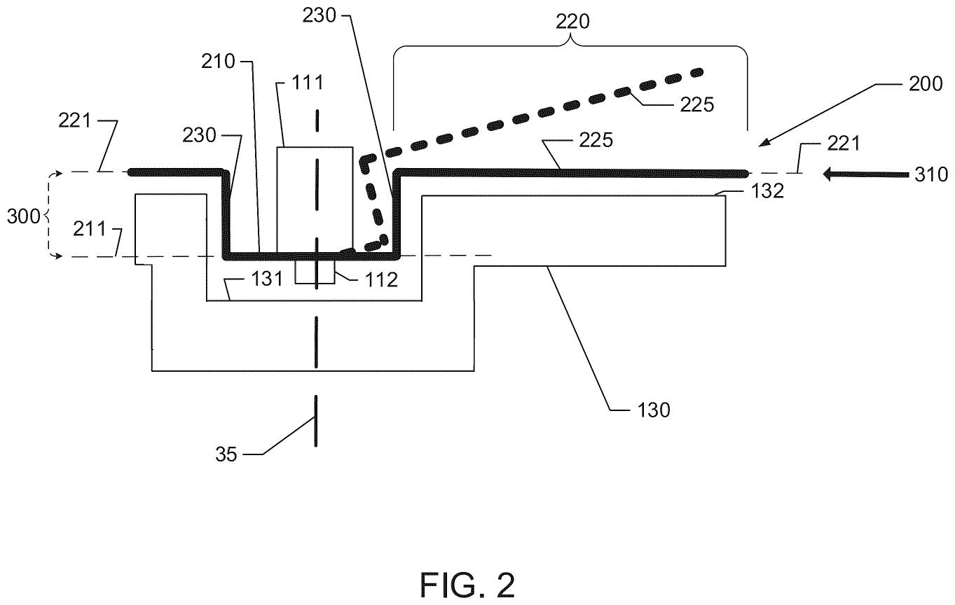

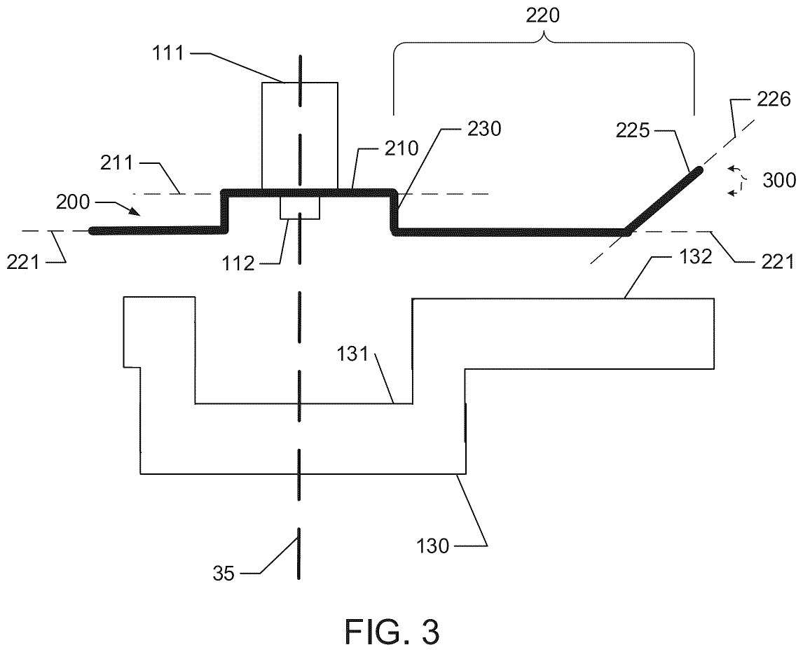

FIG. 1 illustrates a block diagram of a wheel assembly 100 for a vehicle 10 wheel system in accordance with an example embodiment, FIG. 2 illustrates a cross-section side view of a wheel assembly 100 in accordance with an example embodiment, and FIG. 3 depicts a cross-section side view of a wheel assembly 100 in accordance with an example embodiment. As seen in FIGS. 1-3, in some embodiments, the wheel assembly 100 may include a wheel 30, a knuckle 110, a wheel bearing 120, a brake rotor 130, and a brake dust shield 200. A suspension assembly 40 of the vehicle 10 may operably couple to a body 20 and the wheel assembly 100. In some cases, the vehicle 10 may include a chassis or frame. The chassis or frame may support and may form the foundation structure of the vehicle 10. In an example embodiment, the chassis and frame may be formed of one or more casted subframes, and the suspension assembly 40 may be operably coupled to the chassis or frame.

In an example embodiment, the knuckle 110 may operably couple the suspension assembly 40 and the wheel assembly 100 to each other. The knuckle 110 may additionally operably couple to the brake dust shield 200 via a first knuckle coupler 111 of the knuckle 110. The first knuckle coupler 111 may also be referred to as a first knuckle boss or a first knuckle connector. The knuckle 110 may include a first knuckle body portion 115 and a second knuckle body portion 116. The first knuckle body portion 115 may operably couple the suspension assembly 40 and the wheel assembly 100 to each other, and the second knuckle body portion 116 may operably couple the component of the wheel assembly 100 to the knuckle 110. The second knuckle body portion 116 may include the first knuckle coupler 111. In some cases, the brake dust shield 200 may be operably coupled to the first knuckle coupler 111 via a first knuckle fastener 112. In an example embodiment, the first knuckle fastener 112 may be a variety of operable coupling means, such as a nut and bolt, screw, or any other operable coupling means that may secure the brake dust shield 200 to the first knuckle coupler 111. In some cases, the brake dust shield 200 may include a first aperture 201 for operably coupling the brake dust shield 200 and the first knuckle coupler 111. The first aperture 201 and first knuckle coupler 111 may not be limited to a singular aperture or coupler but may include a plurality of first apertures 201 and plurality of first knuckle couplers 111, so that in some cases, the brake dust shield 200 may include a plurality of first apertures 201 for operably coupled the brake dust shield 200 to a plurality of first knuckle couplers 111 in order to properly secure the brake dust shield 200.

In some cases, the brake dust shield 200 may be disposed between the first knuckle body portion 115 and the brake rotor 130. In an example embodiment, the brake rotor 130 may be disposed closer to the wheel 30 than the brake dust shield 200. The disposition of the brake dust shield 200 may allow for the shielding of heat from the brake rotor 130 to components of the suspension assembly 40. For example, the brake dust shield 200 may prevent melting of a rubber boot in a ball joint elements of the suspension assembly 40 that are operably coupled the first knuckle body portion 115 due to acting as a thermal barrier disposed between the brake rotor 130 and the first knuckle body portion 115.

In an example embodiment, the brake rotor 130 may include a brake rotor hat 131. The brake rotor hat 131 may be a depression or concavity in the center of the brake rotor 130. The brake rotor hat 131 may house various component or portions of components of the wheel assembly. In some cases, the brake rotor hat 131 may include a portion of the brake dust shield 200, the wheel bearing 120, and the second knuckle body portion 116. In some cases, the brake rotor 130 may include a brake rotor friction ring 132. The brake rotor friction ring 132 may be disposed radially outward from the brake rotor hat 131. In some cases, the brake rotor friction ring 132 may completely extend around the wheel axis 35 and may completely surround an opening of the brake rotor hat 131. The brake rotor friction ring 132 may be disposed proximate to, but not contacting, the brake dust shield 200.

In some cases, the brake dust shield 200 may include a central body portion 210 and peripheral body portion 220. The central body portion 210 may be centered along a wheel axis 35. The central body portion 210 may be substantially plate shaped and disposed in a first plane 211. The first plane 211 may be substantially perpendicular to the wheel axis 35. The central body portion 210 may be disposed in additional planes other than the first plane 211. In some cases, the first plane 211 of the central body portion 210 may be disposed within the brake rotor hat 131. In an example embodiment, the first plane 211 may be disposed above, not within, the brake rotor hat 131 along the wheel axis 35. The first plane 211 and the central body portion 210 may not overlap with the brake rotor friction ring 132 and may only overlap with a brake rotor hat 131. In an example embodiment, while the brake dust shield 200 may be disposed proximate to the brake rotor 130, the brake dust shield 200 may be operable coupled only to the knuckle 110 and may not contact any other component or element in the vehicle 10 other than the knuckle 110. In some cases, the brake dust shield 200 may be spaced apart from the brake rotor 130 along the entirety of the brake dust shield 200.

In an example embodiment, the peripheral body portion 220 may be positioned radially outward from the central body portion 210 with respect to the wheel axis 35. In some cases, the peripheral body portion 220 may be at least in part disposed in a second plane 221. The second plane 221 may be spaced apart from the first plane 211 along the wheel axis. In an example embodiment, the second plane 221 and the first plane 211 may be substantially parallel to one another.

In some cases, the peripheral body portion 220 may include a positive axial offset surface 225. The positive axial offset surface 225 may be axially offset from the first plane 211 of the central body portion 210 in a direction extending away from the brake rotor 130 to then create a positive axial offset 300. The positive axial offset surface 225 may help to deflect the brake dust shield 200 away from the brake rotor 130 when a radial load 310 may be applied to the brake dust shield 200. In an example embodiment, the positive axial offset surface 225 may be disposed in the second plane 221.

In an example embodiment, a geometry of the brake dust shield 200 may be such that when presented with the radial load 310 at an outer diameter of the brake dust shield 200 in the radial direction towards the wheel axis 35, the brake dust shield 200 may bend away from the brake rotor 130 thus preventing contact and unwanted noise. In some cases, the radial load 310 acting on the brake dust shield 200 may cause the brake dust shield 200 to deflect as depicted by the deflected brake dust shield 400, as shown in FIG. 2. The positive axial offset 300 may ensure that the moment induced from the radial load 310 at the outer diameter of the brake dust shield 200 will cause the brake dust shield 200 to bend away from the brake rotor 130. In an example embodiment, this positive axial offset 300 between the first plane 211 of the brake dust shield 200 and the positive axial offset surface 225 containing the outer diameter of the brake dust shield 200 may enable the bending of the brake dust shield 200 away from the brake rotor 130.

In some cases, the positive axial offset surface 225 may have a positive axial offset 300 along the entirety of the peripheral body portion 220. In an example embodiment, the peripheral body portion 220 may be entirely in the second plane 221, and the positive axial offset 300 may be relatively constant along the entirety of the peripheral body portion (as shown in FIG. 2). In some cases, the positive axial offset surface 225 may only be on a portion of the peripheral body portion 220. The portion of peripheral body portion 220 other than the positive axial offset surface 225 may be considered a remainder portion. A portion of the peripheral body portion 220 disposed in a second plane 221 may be axially offset from the first plane 211 and central body portion 210 in a direction extending towards the brake rotor 130, and a positive axial offset surface 225 of the peripheral body portion 220 may be disposed in a portion of the peripheral body portion 220 that extends away at an acute angle 226 from the second plane 221 at an outer edge of the peripheral body portion 220. The positive axial offset surface 225 that may be disposed in the portion of the peripheral body portion 220 that extends away at an acute angle 226 from the second plane 221 at an outer edge of the peripheral body portion 220 may then have the positive axial offset 300 of the peripheral body portion 220 from the first plane 211, as shown in FIG. 3. The brake dust shield 200, and thus the central body portion 210 and peripheral body portion 220, may be disposed in any number of planes in addition to the first plane 211 and the second plane 221 that may ensure that the positive axial offset 300 may occur between the first plane 211 and the peripheral body portion 220.

In an example embodiment, the positive axial offset 300 of the positive axial offset surface 225 may be a minimum of 5 millimeters. The positive axial offset 300 may be of any distance that may allow for the deflection of the brake dust shield 200 away from the brake rotor 130 if bent and may prevent the contact of the brake dust shield 200 with any other wheel assembly 100 component other than the knuckle 110. The positive axial offset 300 may allow for the biasing of the brake dust shield 200 to bend away from the brake rotor 130 when the brake dust shield 200 experience radial loads.

In some cases, the brake dust shield 200 may be operably coupled with the knuckle 110 at a first plane 211, which may cause the first plane. 211 to be considered a first mounting plane 113 of the knuckle 110. The first mounting plane 113 may then be disposed between the first knuckle body portion 115 and the brake rotor 130. In some cases, the wheel bearing 120 may be operably coupled to the knuckle 110 via the second knuckle body portion 116 at the first mounting plane 113. In an example embodiment, the wheel bearing 120 and the brake dust shield 200 both may be operably coupled to the knuckle 110 at the first mounting plane 113. While the wheel bearing 120 and the brake dust shield 200 may be operably coupled together at the first mounting plane 113, the brake dust shield 200 may still only contact the knuckle 110.

In an example embodiment, the brake dust shield 200 may include a connecting body portion 230. The connecting body portion 230 may operable couple the central body portion 210 and the peripheral body portion 220 to each other. In some cases, the connecting body portion 230 may be angled between 1 degree and 179 degrees in relation to the first plane 211. The connecting body portion 230 may be disposed almost entirely within the brake rotor hat 131. In an example embodiment, the connecting body portion 230 may overlap the brake rotor hat 131 where the connecting body portion 230 may be operably coupled with the central body portion 210 may overlap the brake rotor friction ring 132 where the connecting body portion may be operably coupled with the peripheral body portion 220.

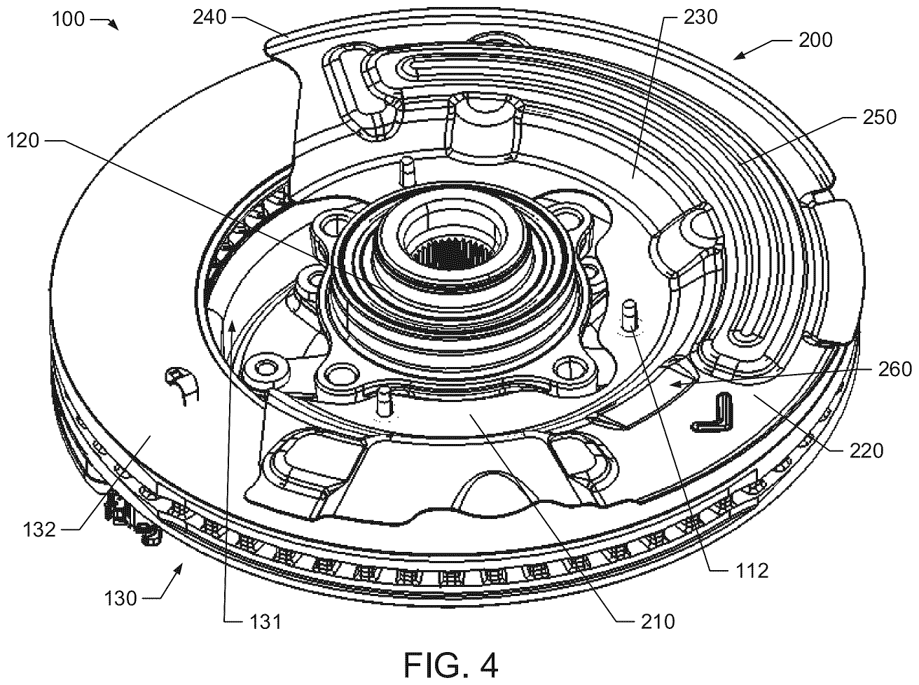

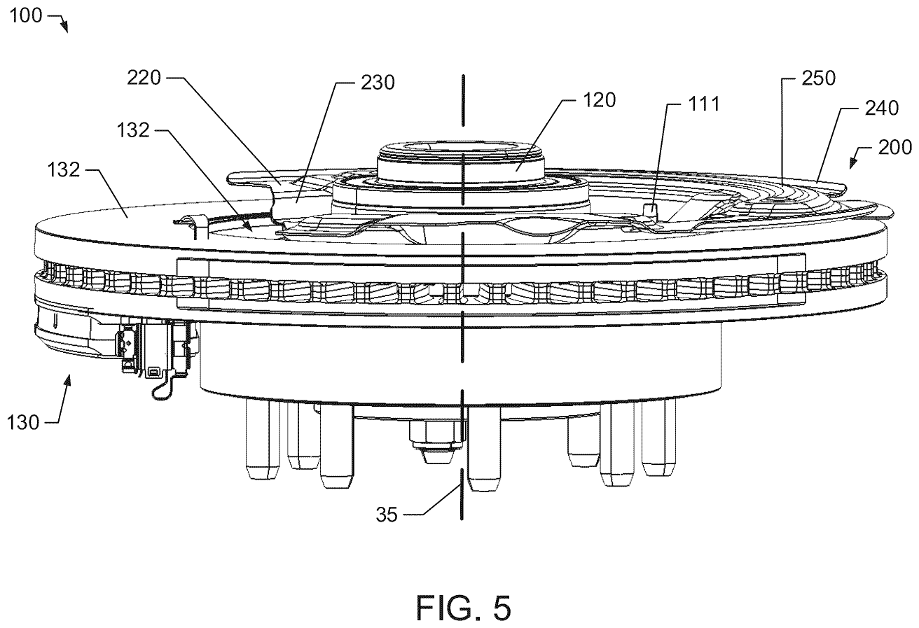

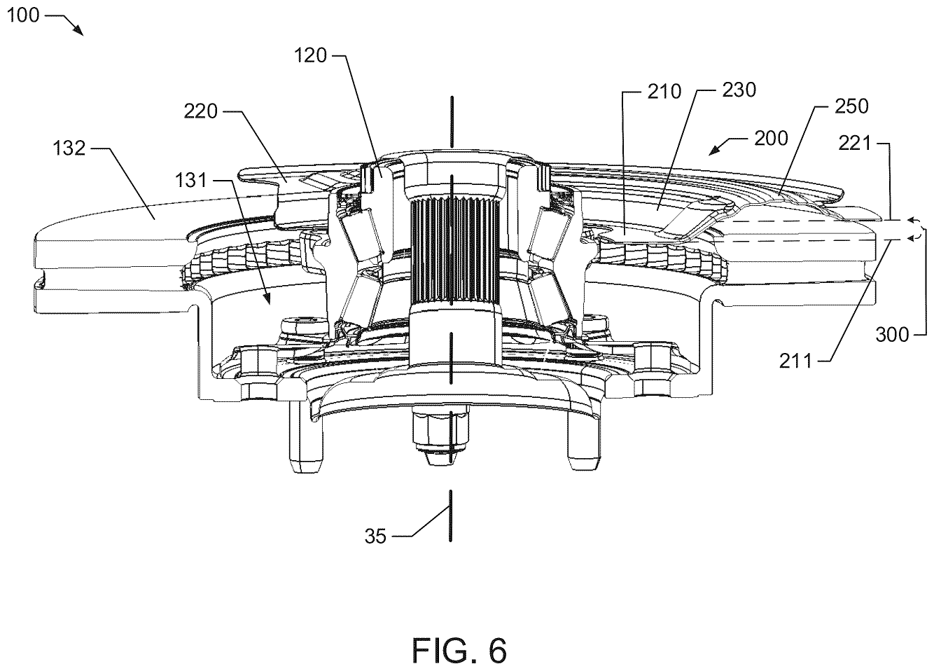

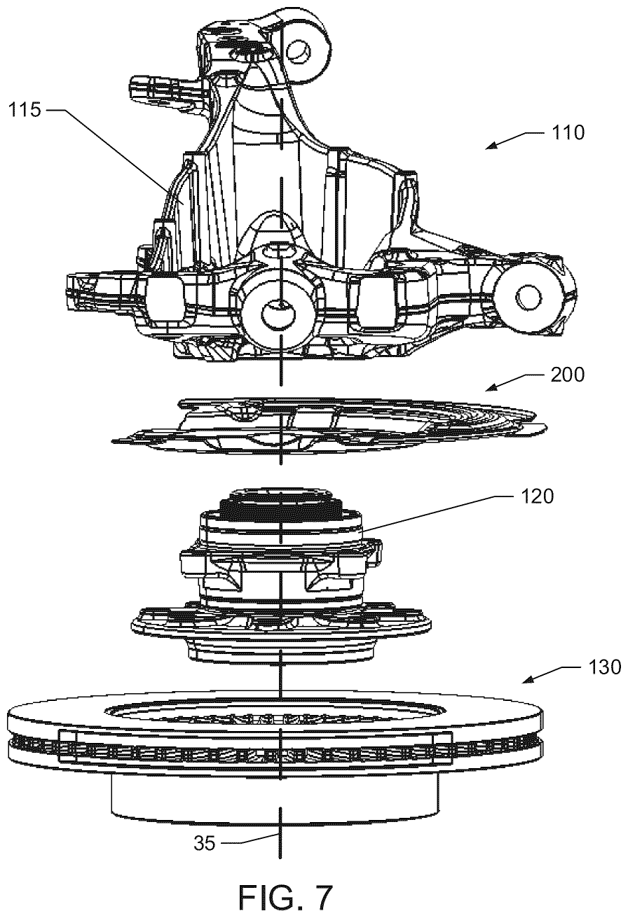

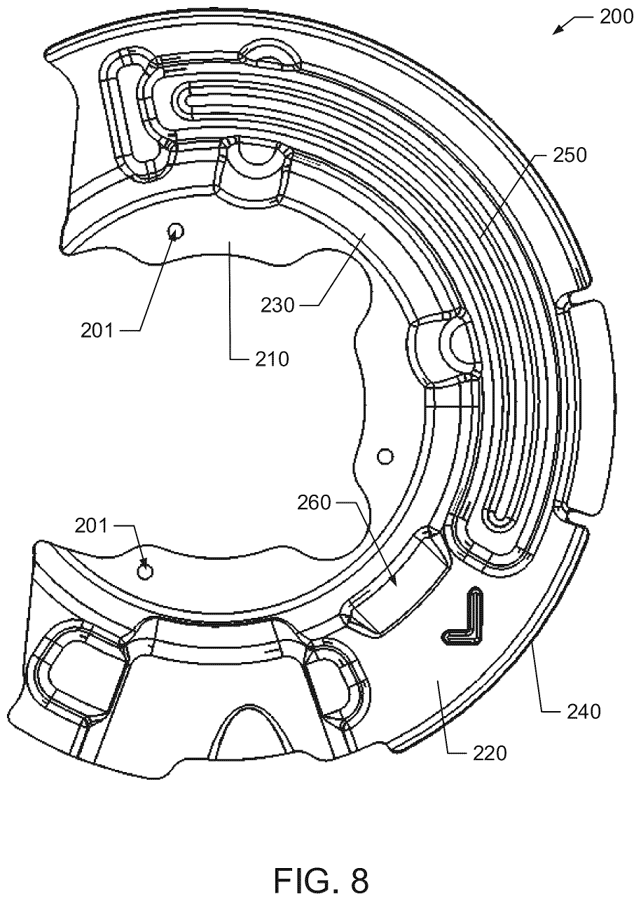

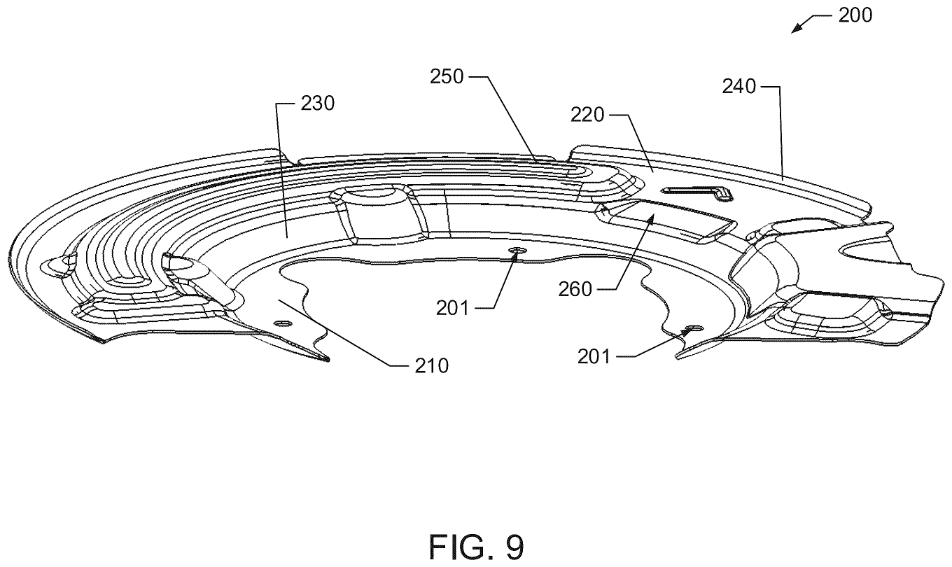

FIG. 4-FIG. 7 illustrate different views of the wheel assembly 100 in accordance with an example embodiment. FIG. 8-FIG. 9 depict different views of the brake dust shield 200 in accordance with an example embodiment. FIG. 4-FIG. 6 do not depict the knuckle 110, but depict a perspective view, a side view, and a cross-section view of the wheel assembly 100 with at least the wheel bearing 120, the brake rotor 130, and the brake dust shield 200. FIG. 7 illustrates a separated view of the wheel assembly 100 including the knuckle 110. As shown in FIG. 4-FIG. 6, the wheel bearing 120 and brake dust shield 200 may partially be disposed within the brake rotor hat 131. In some cases, the brake dust shield 200 may require a clearance between other elements and components of the wheel assembly 100 to limit potential contact. In an example embodiment, the clearance required for the brake dust shield 200 may also extend to the first knuckle coupler 111 and the first knuckle fastener 112 to help limit unwanted potential contact between elements and components of the wheel assembly 100.

In some cases, the brake dust shield 200 may include additional features to help add functionality to the brake dust shield 200, and thus the wheel assembly 100 and vehicle 10 as a whole. The additional features of the brake dust shield 200 may include a structural formation 250 and a second aperture 260. In an example embodiment, the brake dust shield 200 may include a plurality of structural formations 250 and a plurality of second apertures 260. In some cases, the structural formation 250 may be a raised or lowered portion of the brake dust shield 200 that may assist in frequency tuning of the brake dust shield 200. In an example embodiment, the brake dust shield 200 may have a 70 Hz minimum frequency requirement. The structural formation 250 may increase efficiency of brake dust shield 200 through additional factors, such as aerodynamics or manufacturing convenience. The structural formation 250 may be an impression, depression, ridge, groove, trough, furrow, peak, concavity, or any other formation/shape in the brake dust shield 200 to increase brake dust shield 200 functionality.

In some cases, the second aperture 260 may be disposed throughout the brake dust shield 200, such as on any of central body portion 210, peripheral body portion 220, or connecting body portion. In an example embodiment, the second aperture 260 may be a debris fall-out feature for preventing stones, pebbles, and other debris from being trapped within the wheel assembly.

In some cases, the brake dust shield 200 may include a flange 240. The flange 240 may be operably coupled to the peripheral body portion 220 along an outer edge of the peripheral body portion 220. In an example embodiment, the flange 240 may extend away from the brake rotor in the same direction as the axial offset between the first plane 211 and the positive axial offset surface 225. In some cases, the flange 240 may be a plurality of flanges 240. One or more of the plurality of flanges 240 may extend at a different angle from a point of operably coupling or may be a different shape than a different one or more of the plurality of flanges 240. In an example embodiment, the flange 240 may surround at least half of the outer edge of the peripheral body portion 220. In some cases, the flange 240 may surround the entirety of the outer edge of the peripheral body portion 220.

In some cases, the brake dust shield 200 may be unitary. In an example embodiment, the brake dust shield 200 may be manufactured via machining, but the brake dust shield 200 may be manufactured by any number of methods that may not sacrifice brake dust shield 200 robustness, efficiency, durability, or performance. In some cases, the brake dust shield 200 may be sheet metal, but the brake dust shield 200 may be any number of metals or materials that maintain brake dust shield 200 function according to its design. The metal or material of the brake dust shield 200 may have a high stiffness in order prevent crumpling instead of bending of the brake dust shield 200 when deformed under radial loads. In an example embodiment, the brake dust shield 200 may be centered around and may extend only around a portion of the wheel axis 35. The portion the brake dust shield 200 that may extend around the wheel axis 35 may be only 70% around the wheel axis 35. In some cases, the brake dust shield 200 may extend around the entirety of the wheel axis 35. In an example embodiment, the brake dust shield 200 may surround a portion or the entirety of the wheel bearing 120. In some cases, the amount the brake dust shield 200 may surround the wheel bearing 120 may be the same as the amount the brake dust shield 200 surrounds the wheel axis 35. In an example embodiment, the brake dust shield 200 may be c-shaped, crescent shaped, arcuate, substantially circular (circular but not extending 360 degrees around a central point), or any other shape that may not limit the manufacturing/assembly of vehicle or function of the brake dust shield 200.

In some cases, the brake dust shield 200 may not be uniform on opposite sides of the brake dust shield 200 relative the wheel axis 35. For example, in an example embodiment, a radial length of the peripheral body portion 220 on a first side of the brake dust shield 200 may be longer the radial length of peripheral body portion 220 on a second side of the brake dust shield 200.

A brake dust shield for a wheel assembly for a vehicle may therefore be provided. A brake dust shield may include a central body portion that may be radially centered along a wheel axis in a first plane substantially perpendicular to the wheel axis, and a peripheral body portion that may be positioned radially outward from the central body portion disposed at least in part in a second plane spaced apart from the first plane along the wheel axis. The central body portion may be operably coupled to the wheel assembly via a knuckle of the wheel assembly, and the peripheral body portion may include a positive axial offset surface that may be axially offset from the first plane in a direction extending away from the brake rotor.

The brake dust shield for a wheel assembly of a vehicle of some embodiments may include additional features, modifications, augmentations and/or the like to achieve further objectives or enhance performance of the suspension assembly. The additional features, modifications, augmentations and/or the like may be added in any combination with each other. Below is a list of various additional features, modifications, and augmentations that can each be added individually or in any combination with each other. For example, the brake dust shield may not contact any other element of the wheel assembly other than the knuckle. In an example embodiment, the central body portion may be disposed within a brake rotor hat of the brake rotor of the wheel assembly and may not overlap with a friction ring of the brake rotor. In some cases, the first plane and the second plane may be substantially parallel. In an example embodiment, the second plane may be axially offset from the first plane in a direction extending away from the brake rotor along the entirety of peripheral body portion. In some cases, the brake dust shield and a wheel bearing of the wheel assembly may be operably coupled to the knuckle at a first mounting plane of the wheel assembly, and the first mounting plane may be disposed between the brake rotor and a first knuckle body portion. In an example embodiment, the positive axial offset surface may be disposed radially outward with respect to a remainder portion of the peripheral body portion, and the positive axial offset surface is disposed in a portion of the peripheral body portion that extends away at an acute angle from the second plane at an outer edge of the peripheral body portion that extends away from the brake rotor. In some cases, the brake dust shield may include a connecting body portion, the central body portion and the peripheral body portion may be operably coupled to each other via the connecting body portion, and the connecting body portion may be angled between 20 degrees and 90 degrees relative to the first plane of the central body portion. In an example embodiment, the positive axial offset surface may be axially offset from the first plane in a direction extending away from the brake rotor by at least 5 millimeters. In some cases, the peripheral body portion may be operably coupled to a flange extending away from a brake rotor, and the flange surrounds at least half of an outer edge of the peripheral body portion. In an example embodiment, the brake dust shield may surround at least 70% of the wheel bearing.

A wheel assembly for a vehicle of an example embodiment may therefore be provided. The wheel assembly of a vehicle may include a knuckle for operably coupling the wheel assembly and a suspension assembly of the vehicle, a brake rotor for slowing the vehicle, a wheel bearing that may be operably coupled to the knuckle and the brake rotor, and a brake dust shield that may be disposed proximate to the brake rotor. The brake dust shield may include a central body portion that may be radially centered along a wheel axis in a first plane substantially perpendicular to the wheel axis, and a peripheral body portion that may be positioned radially outward from the central body portion disposed at least in part in a second plane spaced apart from the first plane along the wheel axis. The central body portion may be operably coupled to the wheel assembly via a knuckle of the wheel assembly, and the peripheral body portion may include a positive axial offset surface that may be axially offset from the first plane in a direction extending away from the brake rotor.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A brake dust shield for a wheel assembly of a vehicle, the brake dust shield comprising:
a central body portion radially centered along a wheel axis in a first plane substantially perpendicular to the wheel axis;
a peripheral body portion positioned radially outward from the central body portion disposed at least in part in a second plane spaced apart from the first plane along the wheel axis,
wherein the central body portion is operably coupled to the wheel assembly via a knuckle of the wheel assembly, and
wherein the peripheral body portion comprises a positive axial offset surface that is axially offset from the first plane in a direction extending away from a brake rotor.

2. The brake dust shield of claim 1, wherein the brake dust shield does not contact any other element of the wheel assembly other than the knuckle.

3. The brake dust shield of claim 1, wherein the central body portion is disposed within a brake rotor hat of the brake rotor of the wheel assembly and does not overlap with a friction ring of the brake rotor.

4. The brake dust shield of claim 1, wherein the first plane and the second plane are substantially parallel.

5. The brake dust shield of claim 4, wherein the second plane is axially offset from the first plane in a direction extending away from the brake rotor along the entirety of peripheral body portion.

6. The brake dust shield of claim 1, wherein the brake dust shield and a wheel bearing of the wheel assembly are operably coupled to the knuckle at a first mounting plane of the wheel assembly, wherein the first mounting plane is disposed between the brake rotor and a first knuckle body portion.

7. The brake dust shield of claim 1, wherein the positive axial offset surface is disposed radially outward with respect to a remainder portion of the peripheral body portion,
wherein the positive axial offset surface is disposed in a portion of the peripheral body portion that extends away at an acute angle from the second plane at an outer edge of the peripheral body portion that extends away from the brake rotor.

8. The brake dust shield of claim 1, wherein the brake dust shield further comprises a connecting body portion,
wherein the central body portion and the peripheral body portion are operably coupled to each other via the connecting body portion, and
wherein the connecting body portion is angled between 20 degrees and 90 degrees relative to the first plane of the central body portion.

9. The brake dust shield of claim 1, wherein the positive axial offset surface is axially offset from the first plane in a direction extending away from the brake rotor by at least 5 millimeters.

10. The brake dust shield of claim 1, wherein the peripheral body portion is operably coupled to a flange extending away from a brake rotor, and
wherein the flange surrounds at least half of an outer edge of the peripheral body portion.

11. The brake dust shield of claim 1, wherein the brake dust shield surrounds at least 70% of the wheel bearing.

12. A wheel assembly of a vehicle, wherein the wheel assembly comprises:
a knuckle for operably coupling the wheel assembly and a suspension assembly of the vehicle,
a brake rotor for slowing the vehicle,
a wheel bearing operably coupled to the knuckle and the brake rotor,
a brake dust shield disposed proximate to the brake rotor, the brake dust shield further comprising:
a central body portion radially centered along a wheel axis in a first plane substantially perpendicular to the wheel axis;
a peripheral body portion positioned radially outward from the central body portion disposed at least in part in a second plane spaced apart from the first plane along the wheel axis,
wherein the central body portion is operably coupled to the wheel assembly via a knuckle of the wheel assembly, and
wherein the peripheral body portion comprises a positive axial offset surface that is axially offset from the first plane in a direction extending away from the brake rotor.

13. The wheel assembly of claim 12, wherein the brake dust shield does not contact any other element of the wheel assembly other than the knuckle.

14. The wheel assembly of claim 12, wherein the central body portion is disposed within a brake rotor hat of the brake rotor of the wheel assembly and does not overlap with a friction ring of the brake rotor.

15. The wheel assembly of claim 12, wherein the first plane and the second plane are substantially parallel.

16. The wheel assembly of claim 15, wherein the second plane is axially offset from the first plane in a direction extending away from the brake rotor along the entirety of peripheral body portion.

17. The wheel assembly of claim 12, wherein the brake dust shield and a wheel bearing of the wheel assembly are operably coupled to the knuckle at a first mounting plane of the wheel assembly, wherein the first mounting plane is disposed between the brake rotor and a first knuckle body portion.

18. The wheel assembly of claim 12, wherein the positive axial offset surface is disposed radially outward with respect to a remainder portion of the peripheral body portion,
wherein the positive axial offset surface is disposed in a portion of the peripheral body portion that extends away at an acute angle from the second plane at an outer edge of the peripheral body portion that extends away from the brake rotor.

19. The wheel assembly of claim 12, wherein the brake dust shield further comprises a connecting body portion,
wherein the central body portion and the peripheral body portion are operably coupled to each other via the connecting body portion, and
wherein the connecting body portion is angled between 20 degrees and 90 degrees relative to the first plane of the central body portion.

20. The wheel assembly of claim 12, wherein the peripheral body portion is operably coupled to a flange extending away from a brake rotor, and
wherein the flange surrounds at least half of an outer edge of the peripheral body portion.
